(19) United States
(12) Patent Application Publication
(10) Pub. No.: US 2026/0061987 A1
(43) Pub. Date: Mar. 5, 2026

(54) FUEL MANAGEMENT IN HYBRID VEHICLES

(71) Applicant: International Business Machines Corporation, Armonk, NY (US)

(72) Inventors: Guang Han Sui, Beijing (CN); Peng Hui Jiang, Beijing (CN); Su Liu, Austin, TX (US); Jun Su, Beijing (CN); Yu Zhu, Beijing (CN); Jun Feng Duan, Beijing (CN)

(21) Appl. No.: 18/820,763

(22) Filed: Aug. 30, 2024

(51) Int. Cl. B60W 20/15; B60W 50/00; B60W 50/14

(52) U.S. Cl. CPC B60W 20/15; B60W 50/0097; B60W 50/14

(57) ABSTRACT

A computer-implemented method to alter a standard mode of operation in a hybrid vehicle. The method includes generating a driving profile for a hybrid vehicle, wherein the hybrid vehicle comprises an electric motor and a combustion engine. The method further includes estimating, based on the driving profile, an amount of future driving. The method also includes predicting based on the amount of future driving, a fuel burn rate and a fuel expiration. The method includes generating a fuel burn plan configured to burn an amount of fuel prior to the fuel expiration. Further aspects of the present disclosure are directed computer program products containing functionality consistent with the method described above.

### BACKGROUND

The present disclosure relates to hybrid vehicles, and, more specifically, to managing fuel usage in the hybrid vehicles.

Many new automobiles and other vehicles are built with two modes of propulsion. These can be called hybrid or hybrid electric vehicles. One mode is a combustion engine and the other is an electric motor (collectively engines). The vehicles can alternate in which mode they are operating to provide energy to propel the vehicle.

### SUMMARY

Disclosed is a computer-implemented method to alter a standard mode of operation in a hybrid vehicle. The method includes generating a driving profile for a hybrid vehicle, wherein the hybrid vehicle comprises an electric motor and a combustion engine. The method further includes estimating, based on the driving profile, an amount of future driving. The method also includes predicting based on the amount of future driving, a fuel burn rate and a fuel expiration. The method includes generating a fuel burn plan configured to burn an amount of fuel prior to the fuel expiration. Further aspects of the present disclosure are directed to computer program products containing functionality consistent with the method described above.

Further disclosed is a system for implementing a fuel burn plan. The system comprises a processor; and a computer-readable storage medium communicatively coupled to the processor and storing program instructions which, when executed by the processor, are configured to cause the processor to: determine a driving session, for a hybrid vehicle, is initiated. The processor is further configured to initiate, by the hybrid vehicle, a fuel burn plan, wherein the fuel burn plan is configured to alter a standard operation of the hybrid vehicle to burn the fuel before an expiration of an amount of fuel in the vehicle.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for altering a mode of operation in hybrid vehicles to prevent fuel from spoiling, in accordance with some embodiments of the present disclosure.

FIG. 2 is a block diagram of a computing environment suitable for operation of a fuel manager in accordance with some embodiments of the present disclosure.

FIG. 3 is a flow chart of an example method to generate a fuel burn plan, in accordance with some embodiments of the present disclosure.

FIG. 4 is a flow chart of an example method to implement a fuel burn plan, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as altering a mode of operation in a hybrid vehicle to prevent fuel from spoiling of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

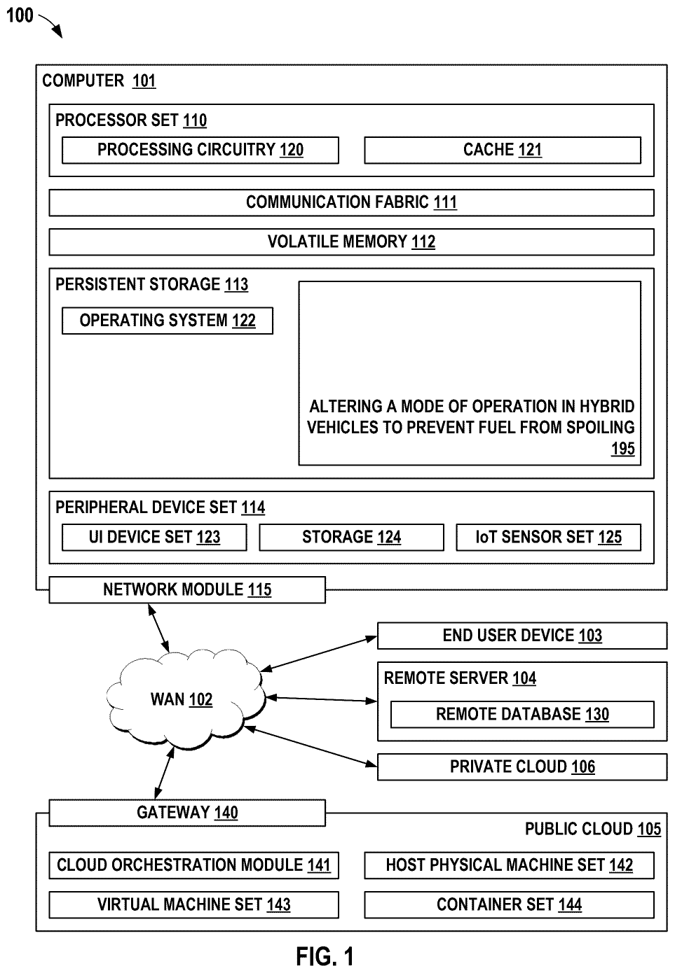

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to hybrid vehicles, and, more specifically, to managing fuel usage in the hybrid vehicles.

Many new automobiles and other vehicles are built with two modes of propulsion. These can be called hybrid or hybrid electric vehicles. One mode is a combustion engine and the other is an electric motor (collectively engines). The vehicles can alternate in which mode they are operating to provide energy to propel the vehicle.

The two engine types have various advantages and disadvantages, and several factors can be used to determine which mode of operation will be used at any particular time. For purposes of this application the mode of operation is referring to which of the two engines is operating. Electric motors will generally have a shorter range than combustion engines. This can be ideal for commuters who take several short trips with charging available while not driving. Alternatively, longer drives or less available charging stations lead to combustion engines being preferred. But combustion engines require gasoline or another fuel to operate.

Many modern automobile fuels contain octane mixed with ethanol, or other similar compounds. However, some additives in automobile fuel, such as ethanol, have a limited shelf life. If they sit in a fuel tank for an extended period they can spoil/expire. The spoil of fuel can be caused by one of several mechanisms. One example, ethanol can absorb water, causing it to become heavier than gasoline and sink to the bottom of the fuel tank. When the combustion engine attempts to burn this fuel, it may reduce the efficiency of and/or cause damage to the combustion engine.

Embodiments of the present disclosure can reduce the likelihood of damage and/or efficiency losses caused by old fuel. Embodiments of the present disclosure include a fuel manager. In some embodiments, the fuel manager selectively alters the mode of operation to the combustion engine to prevent the fuel from expiring. Said differently, the fuel manager can use the combustion engine to burn the fuel before it becomes expired, even when the vehicle would otherwise operate by the electric motor. For purposes of this disclosure, expired fuel, stale fuel, and/or fouled fuel can be used interchangeably.

In some embodiments, the fuel manager can track/monitor an amount of fuel in the fuel tank of a hybrid vehicle. In some embodiments, the tracking includes continuously monitoring a fuel level. For example, when new fuel is added to the vehicle, the amount of fuel, the type of fuel, and time of the addition can be recorded. Additionally, as fuel is burned, the level can be monitored as it decreases. The tracking can be based on automatically obtaining level data from the fuel tank and/or receiving an input with an amount and type of fuel added from an external source. In some embodiments, the monitoring includes tracking the type of fuel added to the fuel tank. The type can include what additives, and in what concentration, are in the fuel. For example, the amount of ethanol, as a percentage, can be monitored. In some embodiments, the monitoring includes tracking the amount of fuel burned by the combustion engine, and determining a rate at which the fuel is burned.

In some embodiments, the fuel manager generates a driving profile for the vehicle. The driving profile can be for one or more drivers of the vehicle. In some embodiments, the driving profile analyzes past usage data to determine driving patterns. The driving patterns include when and/or how often each engine is operating. The driving patterns can monitor past fuel burn rates.

In some embodiments, the fuel manager generates a fuel burn plan. The fuel burn plan can be based on the generated driving profile. In some embodiments, the burn plan is configured to burn fuel prior to the fuel expiring.

In some embodiments, the fuel manager can coordinate with a vehicle manager. The vehicle manager can determine in which mode to operate the vehicle. Said differently, the vehicle manager can determine which of the two engines is operating at any given time. In some embodiments, the vehicle manager coordinates with the fuel manager to toggle between which engine is operating. The vehicle manager can also obtain real time fuel level data to calculate a burn rate. Vehicle manager can send collected data to the fuel manager.

In some embodiments, the vehicle manager receives the fuel burn plan from the fuel manager. During a driving session, the fuel manager can analyze current fuel level and burn rate against the generated fuel burn plan. The vehicle can determine the fuel burn rate is below an expected burn rate per the burn plan. Said differently, the vehicle manager can determine when the actual fuel burn rate is below an expected/plan burn rate. In response, the vehicle manager can alter the fuel burn plan to keep the combustion engine operating longer than planned. The fuel manager can maintain the vehicle in a driving mode using the combustion driving mode (combustion mode) until the actual fuel burn rate returns to the plan burn rate, even when the standard vehicle operation would cause change to an electric driving mode (the electric driving mode is when the vehicle is powered by the electric motor). After the actual burn is equal to or below the fuel burn plan, the vehicle can return to a standard operation, which may include switching to the electric motor for operation.

Embodiments of the present disclosure can improve the life span and/or efficiency of hybrid vehicles by prevent stale fuel from causing unnecessary damage to the vehicle. Additionally, embodiments of the present disclosure can reduce waste by preventing a need to drain stale/expired fuel from the fuel tank.

The aforementioned advantages are example advantages, and embodiments exist that can contain all, or some of the aforementioned advantages while remaining within the spirit and scope of the present disclosure.

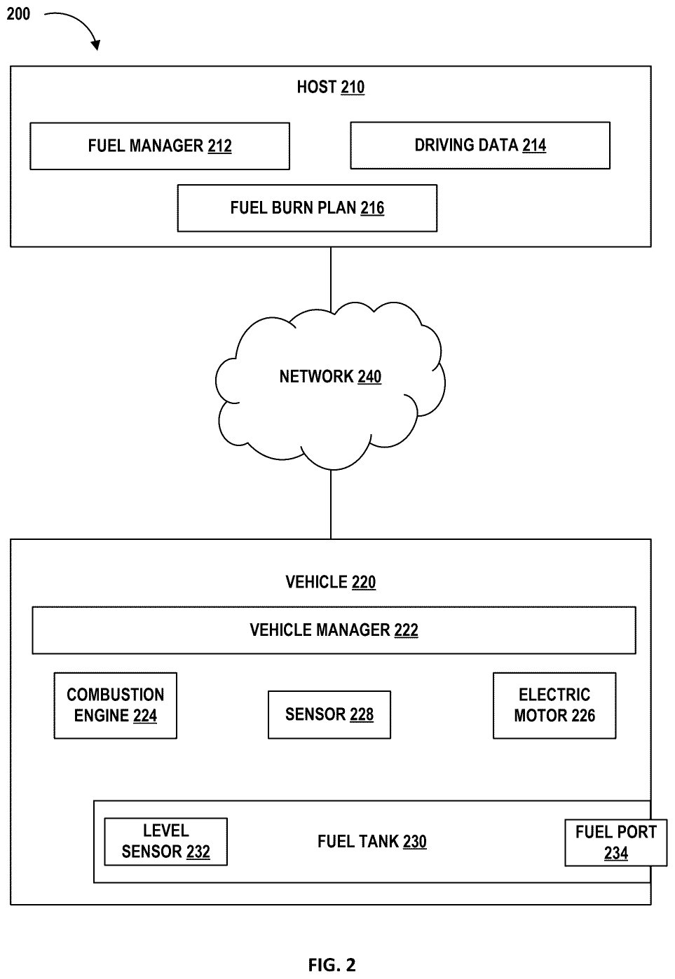

Referring now to various embodiments of the disclosure in more detail, FIG. 2 is a representation of a computing environment 200, that is capable of running a fuel manager and/or a vehicle manager accordance with one or more embodiments of the present disclosure. Many modifications to the depicted environment may be made by those skilled in the art without departing from the scope of the disclosure.

Computing environment 200 includes host 210, vehicle 220, and network 240. Network 240 can be, for example, a telecommunications network, a local area network (LAN), a wide area network (WAN), such as the Internet, or a combination of the three, and can include wired, wireless, or fiber optic connections. Network 240 may include one or more wired and/or wireless networks that are capable of receiving and transmitting data, voice, and/or video signals, including multimedia signals that include voice, data, and video information. In general, network 240 may be any combination of connections and protocols that will support communications between and among host 210, vehicle 220, and other computing devices (not shown) within computing environment 200. In some embodiments, each of host 210, vehicle 220, and other devices not shown may include one or more of a computer system, such as computer 101 of FIG. 1.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 is separate from vehicle 220 and sends and/or received data from vehicle 220 via network 240. In some embodiments, host 210 is incorporated into vehicle 220 and/or vehicle manager 222. This can allow for host 210 to communicate with fuel manager 212 and/or vehicle manager 222 without the need of sending data through network 240.

In some embodiments, host 210 includes fuel manager 212, driving data 214, and fuel burn plan 216. In some embodiments, host 210 and/or any of the subcomponents of host 210 can be incorporated into and/or combined with vehicle 220. However, they are shown as separate for discussion purposes.

Fuel manager 212 can be any combination of hardware and/or software configured to generate fuel burn plan, such as fuel burn plan 216. In some embodiments, fuel burn plan 216 is configured to alter a standard operation of vehicle 220. The alteration includes operating in a combustion engine mode when the circumstances would otherwise dictate operation in an electric motor mode. In some embodiments, fuel manager 212 contains driving data 214 and/or fuel burn plan 216. However, in the depicted embodiment they are shown as separate for discussion purposes.

In some embodiments, fuel manager 212 analyzes driving data 214 to develop a vehicle driving profile. The driving profile can identify trends and patterns for vehicle usage. In some embodiments, the driving profile includes information related to vehicle 220. The information can include data and/or policies for when vehicle 220 utilizes each driving mode, and/or parameters for changing between driving modes. In some embodiments, fuel manager 212 determines if the standard driving profile is used, then the fuel is likely to go stale.

Driving data 214 is a collection of data related to usage of vehicle 220. In some embodiments, driving data 214 includes data about operation of the vehicle. The data can include distance driven, time driven, driving mode (e.g., electric motor, combustion engine, etc.) for distance and time, fuel consumption, location data, battery consumption, battery charging time, amount of fuel added, type of fuel added, weather conditions, driving conditions (e.g., city roads, highways, etc.), identify of the driver, driving mode, and the like. In some embodiments, at least a portion of driving data is captured by sensor 228 on vehicle 220 and/or stored in driving data 214. In some embodiments, at least a portion of the driving data is obtained from publicly available data. Weather conditions are one example data that can be obtained from public sources.

Fuel burn plan 216 can be a generated schedule configured to burn fuel at a rate that will prevent the fuel from expiring. In some embodiments, fuel burn plan 216 is based an analysis of driving data 214. In some embodiments, the fuel burn plan 216 is configured to burn a relatively similar amount of fuel each period of time. The period can be a day, week, and/or driving session. For example, the plan can be to burn one gallon of fuel per day. In another example can be to burn a tenth gallon of fuel each driving session.

In some embodiments, generating fuel burn plan 216 includes predicting future driving patterns. The prediction can be generated by fuel manager 212. In some embodiments, the predicted driving patterns predicts a total amount of driving time and driving mileage. The prediction can be for one or more periods of time. For example, a prediction can have a single day, a week, a month, and a multiple month prediction.

In some embodiments, fuel burn plan 216 can modify a standard operation of vehicle 220. For example, fuel burn plan 216 can include using the combustion engine 224 when vehicle 220 would otherwise use the electric motor 226. In another example is that the combustion engine 224 can operate for a longer period of time than the vehicle 220 standard operations.

Vehicle 220 can be any vehicle that includes an electric motor and a combustion engine. In some embodiments, vehicle 220 can be an automobile, a bicycle, an all-terrain vehicle, farm equipment, watercraft, and any other type of movable machine. In some embodiments, vehicle 220 is a hybrid automobile with two modes of propulsion, an electric motor (e.g., electric motor 226) and a combustion engine (e.g., combustion engine 224). In some embodiments, vehicle 220 includes vehicle manager 222, combustion engine 224, electric motor 226, sensors 228, fuel tank 230, and fuel port 234. In some embodiments, vehicle 220 can include the components of host 210 within and/or in addition to vehicle manager 222. In some embodiments, vehicle 220 includes additional components and features, not shown, that make vehicle 220 operable.

Vehicle manager 222 can be any combination of hardware and/or software configured to manage the driving mode of vehicle 220 and to toggle between the driving modes. In some embodiments, vehicle manager 222 can determine which mode to operate at any given time. In some embodiments, vehicle manager 222 activates and/or deactivates combustion engine 224 and/or electric motor 226. The toggling between the two engines can be automated and/or manual. Various conditions/factors can be used to determine when each engine is used. In some embodiments, vehicle manager 222 has a standard operation mode. The standard mode includes a set of rules for which mode to operate and/or when to switch modes. For example, in one embodiment, electric motor 226 can be utilized until the battery percentage falls below a threshold, then combustion engine 224 is activated and electric motor 226 is deactivated. In some embodiments, vehicle manager 222 is configured to prefer electric motor 226.

Combustion engine 224 can be any combustion based system configured to propel vehicle 220. In some embodiments, combustion engine 224 burns fuel stored in fuel tank 230. In some embodiments, combustion engine 224 can be toggled between activated (active) and deactivated (inactive) as the propulsion mechanism for vehicle 220. In some embodiments, combustion engine 224 can draw fuel from fuel tank 230.

Electric motor 226 can be any battery powered motor configured to propel vehicle 220. In some embodiments, electric motor 226 is powered by a bank of batteries in vehicle 220. The battery bank can be recharged by electrical power sources external to vehicle 220.

Sensor 228 can be any combination of hardware and/or software configured to monitor operation of vehicle 220. In some embodiments, sensor 228 includes two or more sensors in various locations in and/or around vehicle 220. The various sensors can be associated with one or more of combustion engine 224, electric motor 226, and fuel tank 230. Sensor 228 can monitor driving mode, driving speed, driving distance, traffic patterns, acceleration, deceleration, battery power remaining, and other similar relevant information. In some embodiments, data captured by sensor 228 can is sent to vehicle manager 222 and/or driving data 214. The sensor data can be used by vehicle manager 222 to toggle between the two driving modes.

Fuel tank 230 can be any receptacle configured to store fuel to operate combustion engine 224. In some embodiments, fuel tank 230 includes fuel port 234 and level sensor 232. In some embodiments, fuel tank 230 includes one or more predefined fuel levels. These levels can include full, empty, and various in between. Full and empty can be predefined threshold levels in the fuel tank described as a high threshold and a low threshold respectively. The low threshold (empty fuel tank), is when the fuel is at or below the low threshold. There may be some fuel remaining in fuel tank 230 when fuel is at the low threshold. In some embodiments, the low threshold is the level at which combustion engine 224 may get insufficient fuel to operate at a predefined power level.

Level sensor 232 can be any combination of hardware and/or software configured to monitor the amount of fuel in fuel tank 230. In some embodiments, level sensor 232 is a set of two or more different sensors. The two or more sensors can be of the same type and/or different types. In some embodiments, level sensor 232 sends fuel level/amount data to vehicle manager 222. The sending can be at predefined intervals of time, and/or a predetermined level change in the fuel tank. Fuel port 234 can be an opening in fuel tank 230 and/or vehicle 220 which allows fuel to be added to fuel tank 230. Fuel port 234 can provide an opening from the external surface of vehicle 220 to add fuel to fuel tank 230.

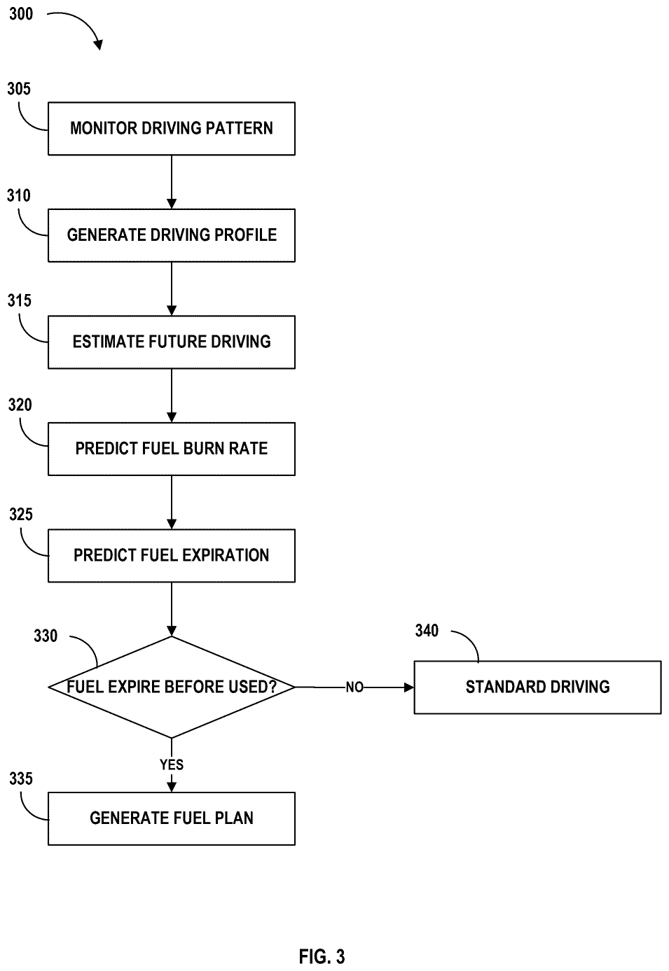

FIG. 3 is a flowchart of an example process 300 for generating a fuel burn plan for a hybrid vehicle that can be performed in a computing environment (e.g., computing environment 100 and/or computing environment 200). One or more of the advantages and improvements described above for generating a fuel burn plan may be realized by process 300, consistent with various embodiments of the present disclosure.

Process 300 can be implemented by one or more processors, host 210, fuel manager 212, driving data 214, vehicle 220, vehicle manager 222, gas engine 224, electric motor 226, sensor 228, level sensor 232, and/or a different combination of hardware and/or software. In various embodiments, the various operations of process 300 are performed by one or more of host 210, fuel manager 212, driving data 214, vehicle 220, vehicle manager 222, gas engine 224, electric motor 226, sensor 228, level sensor 232. For illustrative purposes, the process 300 will be described as being performed by fuel manager 212.

At operation 305, fuel manager 212 monitors a driving pattern for vehicle 220. In some embodiments, data related to the monitored pattern can be stored in driving data 214. The data can be received from vehicle 220 and/or sensor 228. In some embodiments, operation 305 includes analyzing the driving data and/or the monitored patterns. The monitored driving data can include which driver is driving the vehicle, day of week, time of day, driving mode (e.g., combustion engine v. electric motor in operation), driving time, driving distance, weather conditions, fuel used, fuel added, speed, and other similar driving data. In some embodiments, a portion of monitored data can be manually entered by a driver.

At operation 310, fuel manager 212 generates a driving profile. The driving profile is based on analyzing the monitored data. In some embodiments, the driving profile is based on analyzing driving data 214. The driving profile can identify trends and patterns in vehicle usage. In some embodiments, the driving profile includes a breakdown of time driven, distance driven, driving mode for time and distance, fuel consumed, fuel added. The breakdown can be by day, week, month, driver, and other similar factors. In some embodiments, the driving profile determines an average distance driven per driving session and/or for each period. For example, a vehicle may be driven a different distance each day of the week, but have a relatively consistent weekly average. The driving profile can include the average weekly distance in each mode and identify days with longer distances relative the other days in the week (e.g., weekly 200 miles, Tuesdays 2%, Wednesdays 25% or weekly amount). The same can be applied for weeks in month, factor in weather and other similar factors.

At operation 315, fuel manager 212 estimates a future amount of driving. In some embodiments, the future driving is based on analyzing the driving profile. The analysis identifies trends, patterns and periods of driving. For example, the analysis can identify total distance over a period of time, distance per mode of operation, fuel burn rate in various conditions, and the like. In some embodiments, the analysis factors in days of the week, holidays, and other similar data.

In some embodiments, the future driving is based on manual input from a driver. For example, if a user is planning a long drive (e.g., road trip) they can input the estimated date and distance into fuel manager 212. Fuel manager 212 can then use the information to update and/or generate a new estimated amount driving for the relevant periods.

At operation 320, fuel manager 212 calculates a predicted fuel burn rate (or burn rate). In some embodiments, the predicted burn rate is based on the driving profile. In some embodiments, the burn rate is calculated based on a current fuel level. For example, the burn rate can return an estimated time at which the fuel tank will be empty, or at a low-level threshold. In some embodiments, the burn rate is an average amount of fuel burned for period of time. The period of time can be day, week, month, driving session, or the like. In some embodiments, fuel manager 212 can calculate a separate fuel burn for each period of time.

At operation 325, fuel manager 212 generates a predicted expiration date for the fuel. The predicted expiration date can be based on the date the fuel was added to the tank. In some embodiments, operation 325 (and/or process 300) is updated each time fuel is added. In some embodiments, the predicted expiration is based on the type of fuel. For example, an amount of alcohol or other additives to the fuel can have an effect on the predicted expiration. In some embodiments, fuel manager 212 determines new fuel is added based on a change in level in fuel tank 230. In some embodiments, fuel manager 212 receives fuel data from an input by the driver. The input can include an octane level and/or an amount of ethanol mixed in the fuel. In some embodiments, the fuel type is based on what is available in the vicinity of the driver. This can be obtained from publicly available sources and/or by user input.

At operation 330, fuel manager 212 determines if the fuel in the tank will expire before the fuel is used. In some embodiments, the determination is based on the predicted burn rate. In some embodiments, the predicted burn rate is compared to the predicted expiration date. If the predicted expiration is prior to the predicted fuel level reaching a low level threshold, then it is determined that the fuel will expire. If it is determined that the fuel will expire (330:YES), then fuel manager 212 proceeds to operation 335. If it is determined that the fuel will not expire (330:NO), then fuel manager 212 proceeds to operation 340.

At operation 335, fuel manager 212 generate generates a fuel burn plan. In some embodiments, the fuel burn plan is fuel burn plan 216. In some embodiments, the fuel burn plan is configured to alter the standard operation to burn the fuel prior to the predicted expiration. The fuel burn plan can include instruction to maintain combustion engine 224 in operation for additional time when compared to the standard operation. The fuel burn plan be configured to spread the additional operation over several days. In some embodiments, the fuel burn plan is configured to concentrate the fuel burn over a relatively short time period. For example, in one embodiment, the fuel burn plan can be to burn a minimum amount of fuel each day. The minimum amount, when added to all predicted driving days, will burn the fuel before expiration. In another example embodiment, the fuel burn plan can concentrate the fuel burn to a limited number of periods. For example, one day a week can be used to burn a larger amount of fuel in contrast to burning an relatively consistent amount of fuel on each day. In another example, the fuel burn plan can maintain standard operation until the fuel is nearing the predicted expiration (e.g., one week prior to expiration, or any other period), then continuously use the combustion engine until the necessary fuel is burned. In some embodiments, operation 335 includes sending the fuel burn plan to vehicle manager 222.

In some embodiments, operation 340 fuel manager 212 recommends operation per the standard operation of vehicle 220. Operation 340 can include sending the recommendation to vehicle manager 222. In some embodiments, the fuel burn plan is the standard driving plan. For example, if at operation 330, it is determined that the fuel will not expire, then fuel manager 212 can generate a fuel burn plan to operate vehicle 220 per normal operations.

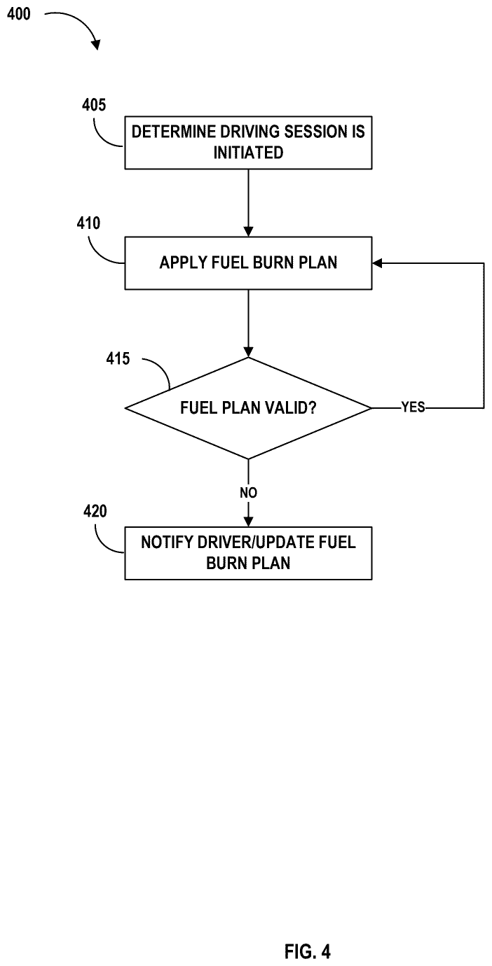

FIG. 4 is a flowchart of an example process 400 for operating a hybrid vehicle according to a fuel burn plan that can be performed in a computing environment (e.g., computing environment 100 and/or computing environment 200). One or more of the advantages and improvements described above operating a hybrid vehicle according to a fuel burn plan may be realized by process 400, consistent with various embodiments of the present disclosure.

Process 400 can be implemented by one or more processors, host 210, fuel manager 212, driving data 214, vehicle 220, vehicle manager 222, gas engine 224, electric motor 226, sensor 228, level sensor 232, and/or a different combination of hardware and/or software. In various embodiments, the various operations of process 300 are performed by one or more of host 210, fuel manager 212, driving data 214, vehicle 220, vehicle manager 222, gas engine 224, electric motor 226, sensor 228, level sensor 232. For illustrative purposes, the process 400 will be described as being performed by vehicle manager 222.

At operation 405, vehicle manager 222 determines a driving session is initiated. In some embodiments, the initiation includes starting the vehicle.

At operation 410, vehicle manager 222 operates vehicle 220 according to fuel burn plan 216. In some embodiments, the fuel burn plan includes standard operation. In some embodiments, the fuel burn plan alters the standard operation of vehicle 220. The alteration can extend the time combustion engine 224 is operating and/or reduce the time electric motor 226 is operating.

At operation 415, vehicle manager 222 determines if the fuel burn plan is still valid. In some embodiments, the fuel burn plan is valid if the predicted low threshold will be met before the predicted expiration of the fuel. In some embodiments, the determination includes comparing the current fuel level to a fuel level in the burn plan for the predicted date. In some embodiments, the determination is based on comparing the predicted driving against the actual driving for a period that has passed. If the actual driving is less, then it can be determined the fuel burn plan is not valid (or is invalid).

If it is determined that the fuel burn plan is valid (415: YES) then vehicle manager 222 returns to operation 410. If it is determined that the fuel burn plan is valid (415: NO) then vehicle manager 222 proceeds to operation 420.

At operation 420, vehicle manager 222 notifies the driver the fuel burn plan is invalid. In some embodiments, operation 420 includes updating the fuel burn plan per one or more operation of process 300. The updating can include keeping vehicle 200 in a combustion engine mode of operation. This can alter both the standard operation and the fuel burn plan.

In some embodiments, the notification can inform the driver that the fuel burn plan is being updated. In some embodiments, the notification can be that the fuel is expired. In some embodiments, the notification includes a message is that the fuel may be expired and/or recommend additional driving to burn the current fuel. If the fuel in fuel tank 230 reaches the predicted expiration date prior to burning, then the fuel is expired. The expiration notification may include recommending a remedial action, such as adding additional fuel, adding a cleaning additive, draining the fuel tank, etc. In some embodiments, vehicle manager 222 will only operate electric motor 226 if the fuel is expired to prevent damage to combustion engine 224.

Embodiments of the present disclosure can reduce efficiency losses and/or damage to a combustion engine by altering a standard driving mode of a hybrid vehicle. The alteration is based on a fuel burn plan configured to burn fuel in a fuel tank at a rate sufficient to prevent the fuel from expiring.

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In summary, various embodiments have been discussed which are again specified in the following numbered clauses:

Clause 1 is as follows. A computer-implemented method comprising: generating a driving profile for a hybrid vehicle, wherein the hybrid vehicle comprises an electric motor and a combustion engine; estimating, based on the driving profile, an amount of future driving; predicting, based on the amount of future driving, a fuel burn rate and a fuel expiration; and generating a fuel burn plan configured to cause the vehicle to burn an amount of fuel in a fuel tank prior to the fuel expiration. Clause 1 has the technical effect of generating a plan to use fuel in an economical way and to prevent damage and/or additional expense to the vehicle.

Clause 2 is as follows. The computer-implemented method of clause 1, wherein the predicting the fuel burn rate is based on a standard operation of the hybrid vehicle. Clause 2 has the technical effect for altering of standard operating procedures to burn the fuel.

Clause 3 is as follows. The computer-implemented method of clause 1 or 2, the method further comprising: determining, based on the predicted fuel burn rate, that the amount of fuel will be above a low level threshold in the fuel tank at the fuel expiration. Clause 3 has the technical effect of further defining how the system is modified.

Clause 4 is as follows. The computer-implemented method of any of the preceding clauses wherein the fuel burn plan alters the standard operation of the hybrid vehicle. Clause 4 has the effect of describing how the standard operation is altered.

Clause 5 is as follows. The computer-implemented method of any of the preceding clauses, wherein the standard operation comprises a set of rules that determines a mode of operation for the hybrid vehicle. Clause 5 has the effect of describing how the standard operation of the vehicle.

Clause 6 is as follows. The computer-implemented method of any of the preceding clauses, wherein the hybrid vehicle has an electric mode where the electric motor provides propulsion and a combustion mode where the combustion engine provides the propulsion. Clause 6 has the effect of describing how the standard operation of the vehicle.

Clause 7 is as follows. The computer-implemented method of any of the preceding clauses wherein the fuel burn plan is configured to use an amount of fuel during each driving session. Clause 7 has the effect of describing how to follow the fuel burn plan.

Clause 8 is as follows. The computer-implemented method of any of the preceding clauses further comprising: initiating a driving session for the hybrid vehicle; and applying the fuel burn plan to the driving session. Clause 8 has the effect of applying the fuel burn plan to a driving scenario.

Clause 9 is as follows. The computer-implemented method of any of the preceding clauses wherein the fuel burn plan is configured to use the combustion engine continuously until the amount of fuel is used. Clause 9 has the effect of describing how to follow the fuel burn plan.

Clause 10 is as follows. The computer-implemented method of any of the preceding clauses, the method further comprising: receiving a set of driving data from the hybrid vehicle, wherein the driving profile is based on the set of driving data, and the driving data is captured by one or more sensors on the hybrid vehicle. Clause 10 has the effect of describing how the profile is used to generate the fuel burn plan.

Clause 11 is as follows. A system comprising: a processor; and a computer-readable storage medium communicatively coupled to the processor and storing program instructions which, when executed by the processor, are configured to cause the processor to: determine a driving session, for a hybrid vehicle, is initiated; initiate, by the processor a fuel burn plan, wherein the fuel burn plan is configured to alter a standard operation of the hybrid vehicle such that the hybrid vehicle will burn the fuel before an expiration of an amount of fuel in the vehicle. Clause 11 has the effect of initiating a fuel burn plan during a driving session.

Clause 12 is as follows. The system according to clause 11 wherein: the hybrid vehicle comprises a combustion engine and an electric motor; and the standard operation of the hybrid vehicle toggles between the electric motor and the combustion engine to propel the hybrid vehicle, based on a set of rules. Clause 12 has the effect of implementing a change in the standard operation.

Clause 13 is as follows. The system according to clause 11 or 12 wherein the standard operation of the vehicle would cause the amount of fuel to expire prior to the amount of fuel in a fuel tank reaching a low level threshold of the fuel tank. Clause 13 has the effect of ensuring the fuel gets burned before spoiling.

Clause 14 is as follows. The system according to any of the clauses 11 through 13 wherein the program instructions are further configured to cause the processor to: receive a predicted expiration date for the amount of fuel; and determine, based on a current date being beyond the predicted expiration date, the amount of fuel is expired. Clause 14 has the effect of implementing a change in the standard operation.

Clause 15 is as follows. The system according to any of the clauses 11 through 14 wherein the program instructions are further configured to cause the processor to: notify a driver of the hybrid vehicle the amount of fuel is past the predicted expiration date; and maintain the hybrid vehicle in an electric motor mode. Clause 15 has the effect of notifying a user of old fuel to prevent damage from inadvertently driving with bad fuel.

Clause 16 is as follows. A computer program product, the computer program product comprising a computer readable storage medium having program instructions embodied therewith, the program instructions executable by a processing unit to cause the processing unit to: generate a driving profile for a hybrid vehicle, wherein the hybrid vehicle comprises an electric motor and a combustion engine; estimate, based on the driving profile, an amount of future driving; predict, based on the amount of future driving, a fuel burn rate and a fuel expiration; and generate a fuel burn plan configured to cause the vehicle to burn an amount of fuel in a fuel tank prior to the fuel expiration. Clause 16 has the technical effect of generating a plan to use fuel in an economical way and to prevent damage and/or additional expense to the vehicle.

Clause 17 is as follows. The computer program product of clause 16 wherein the predicting the fuel burn rate is based on a standard operation of the hybrid vehicle. Clause 17 has the technical effect for altering of standard operating procedures to burn the fuel.

Clause 18 is as follows. The computer program product of clauses 16 or 17, wherein the program instructions are further configured to cause the processing unit to: determine, based on the predicted fuel burn rate, that the amount of fuel will be above a low level threshold in the fuel tank at the fuel expiration. Clause 18 has the technical effect of further defining how the system is modified.

Clause 19 is as follows. The computer program product of any of the clauses 16 through 18, wherein the fuel burn plan alters the standard operation of the hybrid vehicle. Clause 19 has the effect of describing how the standard operation is altered.

Clause 20 is as follows. The computer program product of any of the clauses 16 through 19, wherein the hybrid vehicle has an electric mode where the electric motor provides propulsion and a combustion mode where the combustion engine provides the propulsion and the fuel burn plan is configured to use an amount of fuel during each driving session. Clause 20 has the effect of describing how to follow the fuel burn plan.

What is claimed is:

1. A computer-implemented method comprising:
generating a driving profile for a hybrid vehicle, wherein the hybrid vehicle comprises an electric motor and a combustion engine;
estimating, based on the driving profile, an amount of future driving;
predicting, based on the amount of future driving, a fuel burn rate and a fuel expiration; and
generating a fuel burn plan configured to cause the vehicle to burn an amount of fuel in a fuel tank prior to the fuel expiration.

2. The computer-implemented method of claim 1, wherein the predicting the fuel burn rate is based on a standard operation of the hybrid vehicle.

3. The computer-implemented method of claim 2, the method further comprising:
determining, based on the predicted fuel burn rate, that the amount of fuel will be above a low level threshold in the fuel tank at the fuel expiration.

4. The computer-implemented method of claim 2, wherein the fuel burn plan alters the standard operation of the hybrid vehicle.

5. The computer-implemented method of claim 4, wherein the standard operation comprises a set of rules that determines a mode of operation for the hybrid vehicle.

6. The computer-implemented method of claim 5, wherein the hybrid vehicle has an electric mode where the electric motor provides propulsion and a combustion mode where the combustion engine provides the propulsion.

7. The computer-implemented method of claim 2, wherein the fuel burn plan is configured to use an amount of fuel during each driving session.

8. The computer-implemented method of claim 7, further comprising:
initiating a driving session for the hybrid vehicle; and
applying the fuel burn plan to the driving session.

9. The computer-implemented method of claim 4, wherein the fuel burn plan is configured to use the combustion engine continuously until the amount of fuel is used.

10. The computer-implemented method of claim 1, the method further comprising:
receiving a set of driving data from the hybrid vehicle, wherein the driving profile is based on the set of driving data, and the driving data is captured by one or more sensors on the hybrid vehicle.

11. A system comprising:
a processor; and
a computer-readable storage medium communicatively coupled to the processor and storing program instructions which, when executed by the processor, are configured to cause the processor to:
determine a driving session, for a hybrid vehicle, is initiated;
initiate, by the processor, a fuel burn plan, wherein the fuel burn plan is configured to alter a standard operation of the hybrid vehicle such that the hybrid vehicle will burn the fuel before an expiration of an amount of fuel in the vehicle.

12. The system of claim 11, wherein:
the hybrid vehicle comprises a combustion engine and an electric motor; and
the standard operation of the hybrid vehicle toggles between the electric motor and the combustion engine to propel the hybrid vehicle, based on a set of rules.

13. The system of claim 12, wherein the standard operation of the vehicle would cause the amount of fuel to expire prior to the amount of fuel in a fuel tank reaching a low level threshold of the fuel tank.

14. The system of claim 12, wherein the program instructions are further configured to cause the processor to:
receive a predicted expiration date for the amount of fuel; and
determine, based on a current date being beyond the predicted expiration date, the amount of fuel is expired.

15. The system of claim 14, wherein the program instructions are further configured to cause the processor to:
notify a driver of the hybrid vehicle the amount of fuel is past the predicted expiration date; and
maintain the hybrid vehicle in an electric motor mode.

16. A computer program product, the computer program product comprising a computer readable storage medium having program instructions embodied therewith, the program instructions executable by a processing unit to cause the processing unit to:
generate a driving profile for a hybrid vehicle, wherein the hybrid vehicle comprises an electric motor and a combustion engine;
estimate, based on the driving profile, an amount of future driving;
predict, based on the amount of future driving, a fuel burn rate and a fuel expiration; and
generate a fuel burn plan configured to cause the vehicle to burn an amount of fuel in a fuel tank prior to the fuel expiration.

17. The computer program product of claim 16, wherein the predicting the fuel burn rate is based on a standard operation of the hybrid vehicle.

18. The computer program product of claim 17, wherein the program instructions are further configured to cause the processing unit to:
determine, based on the predicted fuel burn rate, that the amount of fuel will be above a low level threshold in the fuel tank at the fuel expiration.

19. The computer program product of claim 17, wherein the fuel burn plan alters the standard operation of the hybrid vehicle.

20. The computer program product of claim 19, wherein the hybrid vehicle has an electric mode where the electric motor provides propulsion and a combustion mode where the combustion engine provides the propulsion and the fuel burn plan is configured to use an amount of fuel during each driving session.
